(19) United States
(12) Patent Application Publication
(10) Pub. No.: US 2009/0300845 A1
(43) Pub. Date: Dec. 10, 2009

(54) Multi position support apparatus with a movable frame

(76) Inventors: Ohad Paz, Tel Aviv (IL); Ofer Parezky, Ness-Ziona (IL)

Correspondence Address: Active Knowledge Ltd., POB 294, Kiryat Tivon, 36010, omitted

(21) Appl. No.: 12/542,913

(22) Filed: Aug. 18, 2009

Related U.S. Application Data
(63) Continuation-in-part of application No. 11/715,410, filed on Mar. 8, 2007.
Application No. 11/715,410 is a continuation-in-part of application No. PCT/IL2006/000575, filed on May 16, 2006.
(60) Provisional application No. 61/090,433, filed on Aug. 20, 2008.
(60) Provisional application No. 61/097,255, filed on Sep. 16, 2008.
(60) Provisional application No. 60/715,147, filed on Sep. 9, 2005.
(60) Provisional application No. 60/715,177, filed on Sep. 9, 2005.
(60) Provisional application No. 60/738,592, filed on Nov. 22, 2005.

(51) Int. Cl. A61G 7/005

(52) U.S. Cl. 5/610

(57) ABSTRACT

A multi-position support apparatus including a foot support, a tilting element, and a moving frame. The foot support is coupled to the tilting element, and the moving frame is configured to move in relation to the tilting element and below the foot support. Optionally, the moving frame supports a mattress. When the moving frame moves, the mattress supported by the moving frame moves also, thereby achieving a relative movement between the foot support and the mattress. The multi-position support apparatus is capable of changing its height and angle in relation to the ground and moving from an approximately vertical position to an approximately horizontal position.

### CROSS-REFERENCE TO RELATED APPLICATIONS

This application claims the benefit of U.S. Provisional Patent Application No. 61/090,433, filed on Aug. 20, 2008, entitled “A multi position bed with a movable mattress”. This application also claims the benefit of U.S. Provisional Patent Application No. 61/097,255, filed on Sep. 16, 2008, entitled “Multi position bed with a movable frame”. This application is also a continuation-in-part of U.S. patent application Ser. No. 11/715,410, filed on May 17, 2005, entitled “Multi-position support apparatus featuring a movable foot support”, incorporated herein by reference. U.S. Ser. No. 11/715,410 is a Continuation-In-Part of PCT application number PCT/IL2006/000575 filed on May 16, 2006, entitled “Multi-position support apparatus featuring a motorized foot support”. PCT/IL2006/000575 claims priority to U.S. patent application Ser. No. 11/130,129, entitled “Massage and bathing chair”, filed on May 17, 2005, and U.S. patent application Ser. No. 11/130,130, entitled “Patient support apparatus”, filed on May 17, 2005, and U.S. Provisional Patent Application No. 60/715,147, entitled “Bathing system and corresponding method”, filed on Sep. 9, 2005, and U.S. Provisional Patent Application No. 60/715,177, entitled “Multi-position support apparatus featuring a motorized foot support”, filed on Sep. 9, 2005, and U.S. Provisional Patent Application No. 60/738,592, entitled “Bathing system featuring springs elements surface”, filed on Nov. 22, 2005.

### TECHNICAL FIELD

The embodiments of the present invention relate to a multi-position support apparatus, such as a bed, and more particularly, to a multi-position support apparatus with a movable frame.

### BACKGROUND

Hereinafter, the term “engine” refers to any device that is able to move things, including, but not limited to motor or actuator.

Basic principles and details relating to a multi-position bed featuring a movable frame needed for properly understanding the embodiments of the present invention are provided herein. Complete theoretical descriptions, details, explanations, examples, and applications of these and related subjects and phenomena are readily available in standard references in the fields of physics, electronics, homecare devices, and elderly care.

To date, the inventor is unaware of prior art teaching of a multi-position bed featuring a foot support coupled to a tilting element, and a mattress coupled to a moving frame that moves in relation to the tilting element.

Thus there is a need for, and it would be highly advantageous to have, a multi-position bed with a movable frame.

### BRIEF SUMMARY

A multi-position support apparatus including a foot support, a tilting element, and a moving frame. The foot support is coupled to the tilting element, and the moving frame is configured to move in relation to the tilting element and below the foot support. Optionally, the moving frame supports a mattress. When the moving frame moves, the mattress supported by the moving frame moves also, thereby achieving a relative movement between the foot support and the mattress. The multi-position support apparatus is capable of changing its height and angle in relation to the ground and moving from an approximately vertical position to an approximately horizontal position.

The embodiments of the present invention are readily implemented using standard hardware components and standard software modules. Moreover, the embodiments are generally applicable as a ‘stand-alone’ multi-position support apparatus, such as a multi-position bed, or as a multi-position support apparatus used in combination with other methods, devices, and systems, performing various operations.

Implementation of the multi-position support apparatus embodiments involves performing or completing selected tasks or steps manually, semi-automatically, fully automatically, and/or a combination thereof. Moreover, depending upon actual instrumentation and/or equipment used for implementing a particular embodiment of the disclosed system and corresponding method, several embodiments could be achieved by hardware, by software on any operating system of any firmware, or a combination thereof. In particular, as hardware, embodiments of the invention could exist by variations in the physical structure. Additionally, or alternatively, as software, selected functions of the invention could be performed by a data processor, such as a computing platform executing software instructions or protocols using any suitable computer operating system.

### BRIEF DESCRIPTION OF THE DRAWINGS

The embodiments of the present invention are herein described, by way of example only, with reference to the accompanying drawings. With specific reference now to the drawings, it is stressed that the particulars shown are by way of example and for purposes of illustrative discussion of the embodiments of the present invention only, and are presented in order to provide what is believed to be the most useful and readily understood description of the principles and conceptual aspects of the embodiments. In this regard, no attempt is made to show structural details of the embodiments in more detail than is necessary for a fundamental understanding of the invention, the description taken with the drawings making apparent to those skilled in the art how the several forms of the invention may be embodied in practice. In the drawings:

FIG. 1 illustrates a horizontal movement of the moving frame of a multi-position bed, in accordance with the present invention;

FIG. 2 illustrates a horizontal movement of the moving frame of a multi-position bed, in accordance with the present invention;

FIG. 3 illustrates a sitting position of the multi-position bed, in accordance with the present invention;

FIG. 4 illustrates an approximately vertical movement of the moving frame and the tilting element, in accordance with the present invention;

FIG. 5 illustrates an approximately vertical movement of the moving frame and the tilting element, in accordance with the present invention;

FIG. 6 illustrates an approximately vertical movement of the moving frame, and up and down movement of the lifting section of a multi-position bed, in accordance with the present invention; and

FIG. 7 illustrates an approximately vertical movement of the moving frame and the tilting element, in accordance with the present invention.

### DETAILED DESCRIPTION

In the following description, numerous specific details are set forth. However, the embodiments of the invention may be practiced without these specific details. In other instances, well-known hardware, software, materials, structures and techniques have not been shown in detail in order not to obscure the understanding of this description. In this description, references to “one embodiment” or “an embodiment” mean that the feature being referred to is included in at least one embodiment of the invention. Moreover, separate references to “one embodiment” in this description do not necessarily refer to the same embodiment. Illustrated embodiments are not mutually exclusive, unless so stated and except as will be readily apparent to those of ordinary skill in the art. Thus, the invention may include any variety of combinations and/or integrations of the embodiments described herein. Also herein, flow diagrams illustrate non-limiting embodiment examples of the methods, and block diagrams illustrate non-limiting embodiment examples of the devices. Some flow diagrams operations are described with reference to the embodiments illustrated by the block diagrams. However, the methods of the flow diagrams could be performed by embodiments of the invention other than those discussed with reference to the block diagrams, and embodiments discussed with reference to the block diagrams could perform operations different than those discussed with reference to the flow diagrams. Moreover, although the flow diagrams may depict serial operations, certain embodiments could perform certain operations in parallel and/or in different orders than those depicted. Moreover, repeated reference numerals and/or letters in the text and/or drawings are for the purpose of simplicity and clarity and do not in themselves dictate a relationship between the various embodiments and/or configurations discussed.

Unhealthy people in different conditions and elderly people have difficulty bending over and moving from a standing position to a sitting position, and vice versa. As a result, the action of sitting down on a bed is difficult for them. Overweight and/or obese people sometimes find it difficult to bend their knees when sitting down on a bed, and have difficulty rising up off a bed.

The disclosed embodiments of the multi-position support apparatus, referred to as multi-position bed, receive and lower the user from a standing position (while both the multi-position bed and user are about vertical), into a reclining or horizontal position, optionally without having to tie and/or secure the user to the multi-position bed before the angular position change occurs. Then, when the user wants to get out of the multi-position bed, the multi-position bed raises the user from lying down to standing up.

In one embodiment, a multi-position bed includes at least a tilting element and a moving frame. The moving frame may move in relation to the tilting element. A foot support is coupled to the tilting element such that when the moving frame moves in relation to the tilting element, the position of the foot support in relation to the moving frame changes. Optionally, the moving frame supports a mattress. When the moving frame moves, the mattress supported by the moving frame moves also, thereby, achieving a relative movement between the foot support and the mattress.

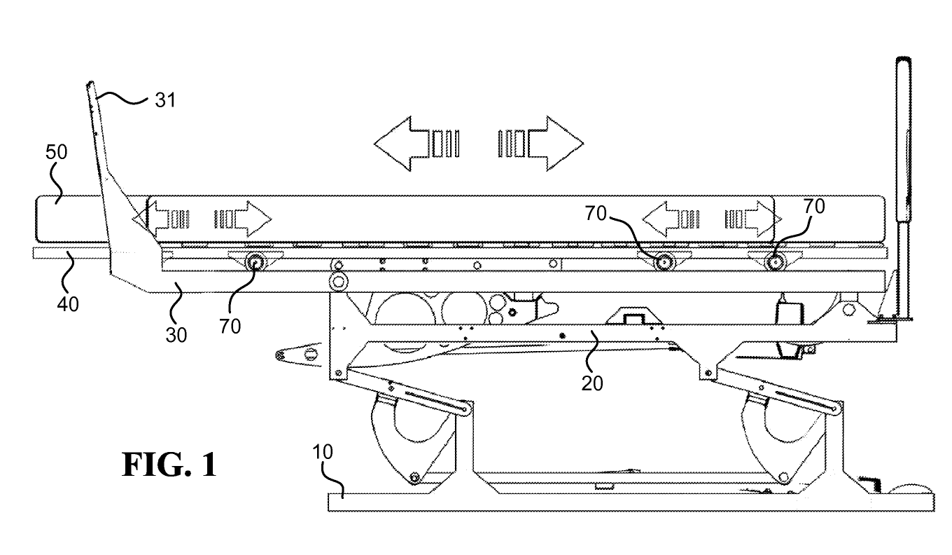

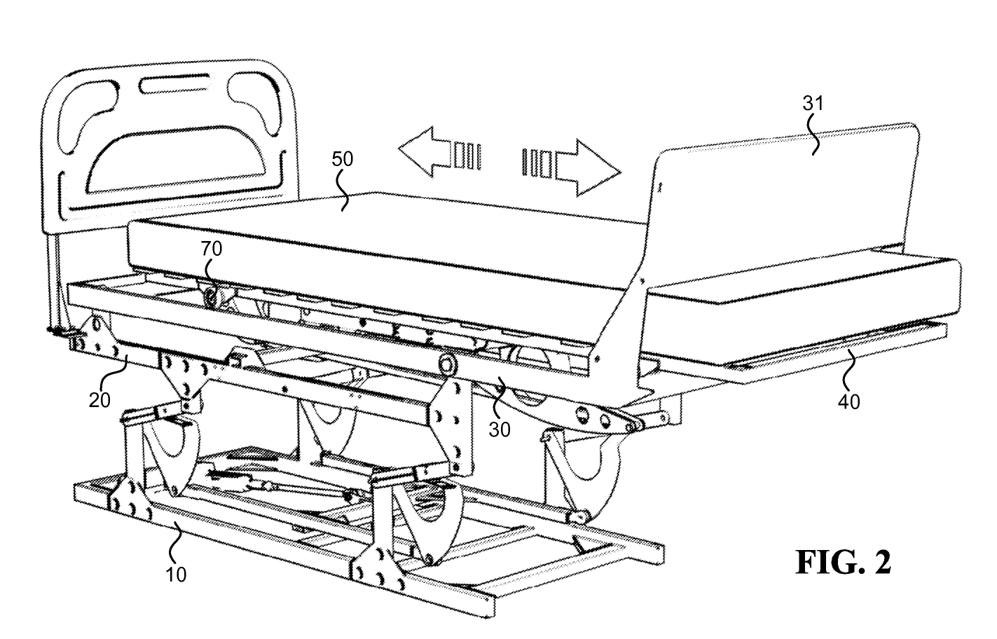

Referring to the figures, FIG. 1 and FIG. 2 illustrate one embodiment of a multi-position bed comprising a base element 10, an optional lifting element 20, a tilting element 30, a foot support 31 coupled to the tilting element 30, and a moving frame 40. Optional mattress 50 is coupled to the moving frame 40. In one embodiment, the foot support 31 is fixed to the tilting element 30 and does not move independently. Therefore, when the tilting element 30 moves, the foot support 31 also moves. When the moving frame 40 moves in relation to the tilting element 30, the foot support 31 does not move and therefore a relative movement between the moving frame 40 and the foot support 31 is obtained. Due to the fact that the mattress 50 is coupled to the moving frame 40, the relative movement between the tilting element 30 and the moving frame 40 causes a relative movement between a user lie down on the mattress 50 and the foot support 31. As a result, the distance between the user's feet and the foot support 31 can be controlled by controlling the relative position of the moving frame 40 in relation to the tilting element 30.

When lifting element 20 is moved up and down, it changes the position of the tilting element 30 and the foot support 31 in relation to the floor. When the tilting element 30 is in maximum tilt and the lifting element 20 is lowered, the foot support 31 is approximately parallel to the ground.

In one embodiment, wheels, bearings, ball bearings, roller bearings, slides, and/or pistons, all referred to as bearings 70, are utilized for enabling the movement of the movable frame in relation to the tilting element. Optionally, the moving frame, to which the mattress is coupled, is actuated by an engine.

In one embodiment, it is possible to change the position of the foot support 31 in relation to the tilting element 30. In one embodiment, it is possible to bring the foot support 31 up or down in relation to the tilting element 30.

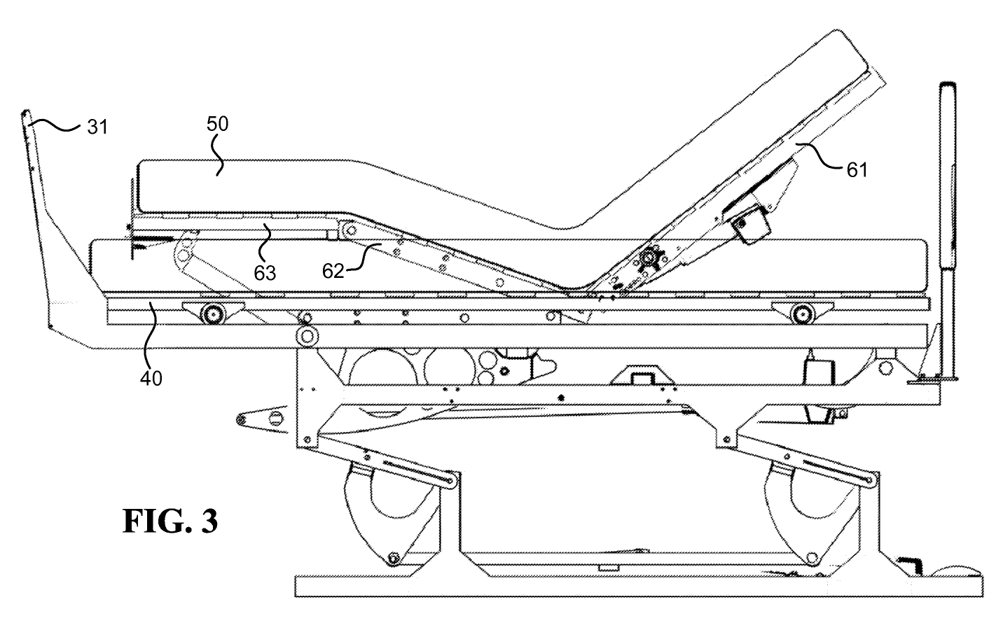

In one embodiment, the moving frame 40 may include at least two angular support elements 60 coupled to the moving frame 40. The angular support elements 60 may change their relative angular positions. FIG. 3 illustrates a moving frame 40 having three angular support elements 60. The first angular support element 61 supports the back rest, the second angular support element 62 supports the seat, and the third angular support element 63 supports the leg rest. While changing the angular position between the different angular support elements 61-63 of the moving frame 40, the multi-position bed may change or maintain the position of the foot support 31 in relation to the moving frame 40. Optionally, the multi-position bed may also change the angular position between the various angular support elements 61-63 while maintaining the relative position between the mattress 50 and the foot support 31. Alternatively, the multi-position bed may change the angular position between the angular support elements 61-63 while also changing the relative position between the mattress 50 and the foot support 31.

FIG. 3 also illustrates the possibility of changing the multi-position bed from a lying position to a sitting position. Since the foot support 31 is fixed to the tilting element 30, it does not move when the mattress 50, coupled to the moving frame 40, moves. Thus if the user wishes to have more space between his legs and the foot support 31 when lifting the back rest using the angular support elements, the user may move the moving frame 40 over the tilting element 30, and thereby draw away from the foot support 31.

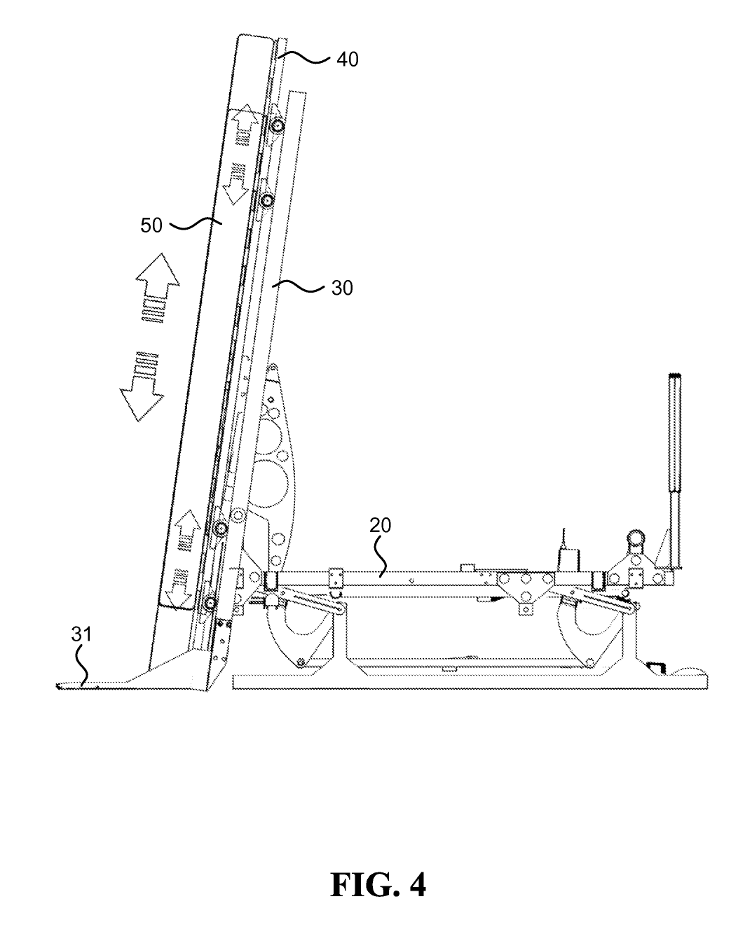

FIG. 4 illustrates an embodiment of a multi-position bed with a movable frame 40 in a standing position. In this position, the tilting element 30 tilts the moving frame 40 into an approximately vertical position, and the foot support 31 touches the ground while the moving frame 20 moves up or down. As the moving frame 20 moves, a user who is leaning against the optional mattress 50 also moves with the mattress 50 coupled to the moving frame 40. The foot support 31 prevents the user from sliding as the multi-position bed shifts from a lying position to a standing position and/or when the multi-position bed shifts from a sitting position to a standing position. When the user wishes to stand up from lying down or sitting position, the moving frame 40 moves toward the foot of the bed until the user's feet reach the foot support 31 that is coupled to the tilting element 30.

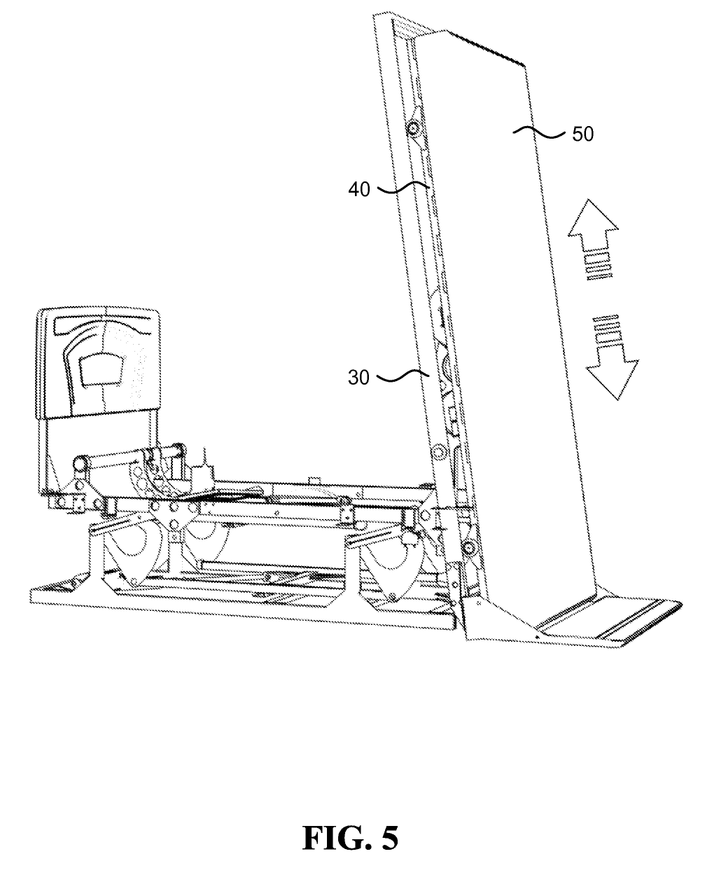

FIG. 5 illustrates another viewpoint of the movement of the moving frame 40 with the optional mattress 50 in relation to the tilting element 30.

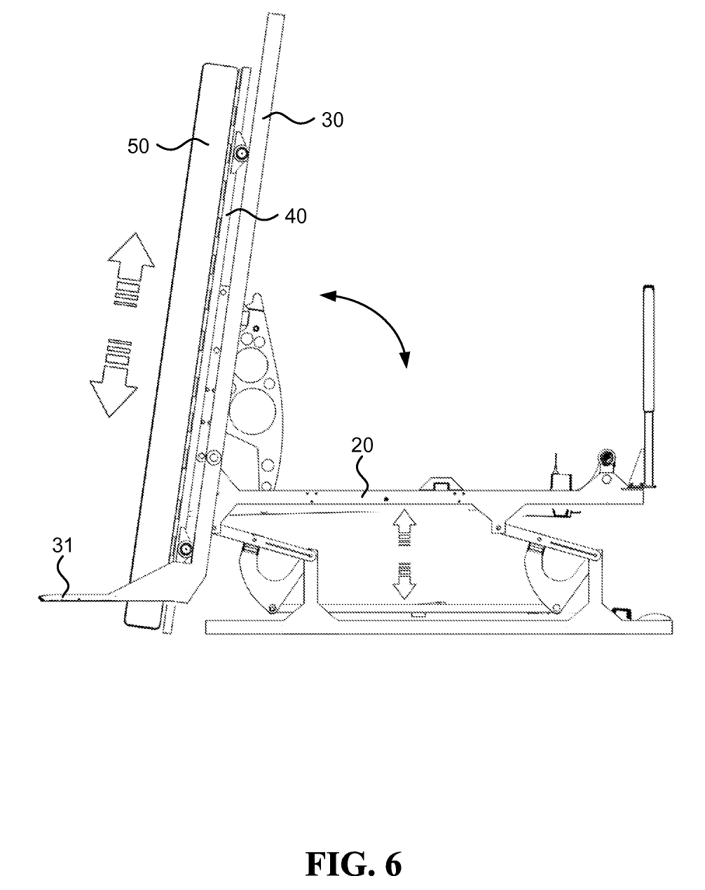

FIG. 6 illustrates an embodiment of a multi-position bed with a movable frame 20, wherein the configuration is changed from a reclining position to a standing position or vice versa. FIG. 6 also illustrates the capability of the optional lifting element 20 to raise and lower the tilting element 30 and the moving frame 40. The foot support 31 that is fixed to the tilting element 30 also moves up and down with the lifting element 20. In order to bring the user from a reclining position to a standing position, the moving frame with the mattress moves down, such that the user's feet touch the foot support. The foot support prevents the user from sliding as the multi-position bed shifts from a reclining position to a standing position and/or as the multi-position bed shifts from a sitting position to a standing position. When the user's feet are on the foot support 31 and the tilting element 30 is at a certain angle, such as above 45 degrees, movement of the moving frame 40, with or without the mattress 50, changes the position of the user on the moving frame 40, while keeping the user standing on the foot support 31, such that the location of the moving frame 40 in relation to the ground changes, while the location of the user does not change as he stands on the foot support 31. The movements of the lifting element 20, the tilting element 30, and the moving frame 40 can either occur simultaneously or sequentially.

It is to be understood that the multi-position bed may have a plurality of states and configurations. For example, the operation of the tilting element 30 and the lifting element 20 may bring the foot support 31 approximately to the ground. Alternatively, operation of the tilting element 30 and the lifting element 20 may bring the foot support 31 to a predefined height above the ground.

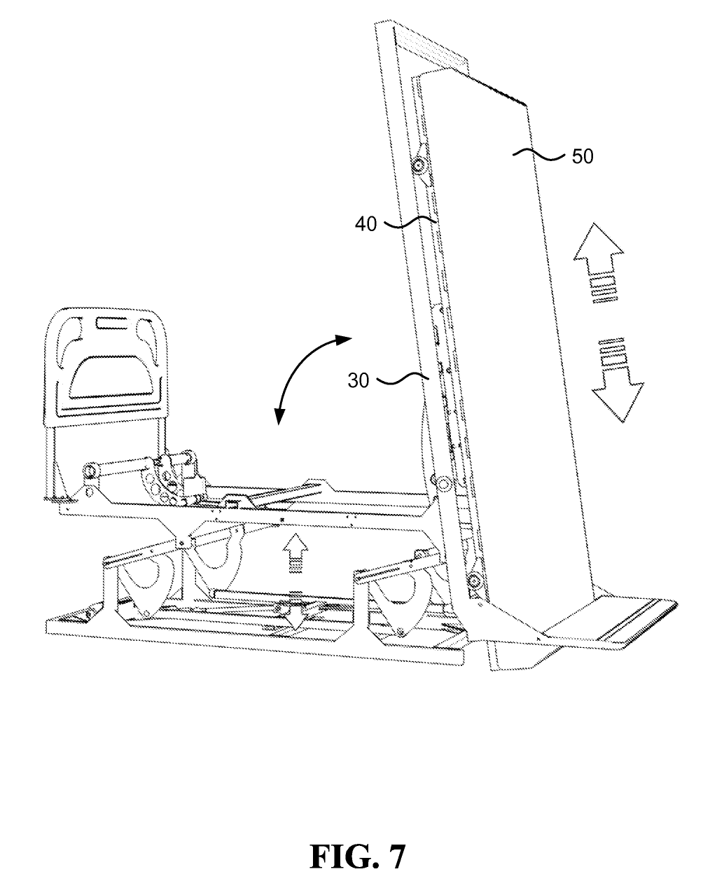

FIG. 7 illustrates from another point of view the embodiment of a multi-position bed with a movable frame, wherein the configuration is changed from a reclining position to a standing position.

Due to the fact that the multi-position bed may move up, down, and to the side utilizing the lifting element 20 and the tilting element 30, a three-dimensional movement of the moving frame 40 becomes possible and enables the user to be brought to many positions.

Detecting when the feet of the user lying in the multi-position bed have reached the foot support 31 may be achieved in various ways, such as, but not limited to, using a pressure sensor that measures the user's legs' intensity of resistance. The minimal threshold of intensity measured by the sensor should be set to a value that is high enough to ensure that the user's feet have actually reached the foot support, and not another object that may be on the multi-position bed. For example, as a safety precaution, the user is not brought to a standing position while stepping on a blanket or a pillow.

However, if the user indeed wants to be brought to a standing position while stepping on a blanket or a pillow, the pressure sensor should be configured and set to ensure that a minimal predefined amount of pressure is applied, implying that the object is pressed to the user's feet. Only when the appropriate amount of pressure is measured by the sensor, will the multi-position bed begin to rise to a standing position. In another embodiment, the sensor is a proximity sensor, or any other sensor able to detect the relative location of the user's feet in relation to the foot support.

In one embodiment, when the user wishes to be brought to a standing position, the tilting element 30 of the multi-position bed starts to change its angular position as the moving frame 40 moves towards the direction of the foot of the multi-position bed. Performing these two actions simultaneously saves time and does not endanger the user, as long as the user's feet reach the foot support in a reasonable amount of time in relation to the angular position of the multi-position bed.

In order for the user to avoid having to descend a step when brought into standing position, and optionally to avoid friction of the user on the mattress, when the multi-position bed reaches a predefined angle, the lifting element 20 to which the tilting element 30 is coupled starts to come down so that the foot support 31 is in close proximity to ground level.

In one embodiment, the multi-position bed features wheels which enable it to move. In an alternative embodiment, the wheels which enable the multi-position bed to move are motorized. In the case where the wheels which enable the bed to move are motorized, it is possible to control the movement of the bed using a control panel. The control panel allows the user to operate the different engines separately, and/or to perform complete operations such as the transition from a standing position to a sitting position and vice versa, the transition from a standing position to a lying position and vice versa, and the transition from a sitting position to a lying position and vice versa. Optionally, the control panel allows the user to stop the multi-position support apparatus in any of the intermediate states of the above described complete operations.

In one embodiment, the multi-position bed is equipped with a toilet bowl. Optionally, when the toilet bowl is being used, the multi-position bed shifts to a sitting position. Optionally, the toilet bowl usage is indicated by the user via a control panel (not shown in the figures).

In one embodiment, the multi-position bed may also be used as a chair. In one embodiment, the multi-position bed may be moved into a sitting position, like a TV recliner.

In one embodiment, the multi-position bed is utilized for a bathing or washing system. In this case, the bathing or washing system may further include one or more sprinklers, one or more dryers, a drain system, and other bathing related devices.

In one embodiment, the multi-position bed is capable of identifying the user. Then, a personalized program may be executed. Angles and velocities are examples of some of the parameters which may be saved in the personalized program.

In one embodiment, the multi-position bed is operated manually. The manual operating program activates each step/stage according to instructions from either the user or any other human operator. Alternatively, the multi-position bed is operated by an automatic program that activates all stages, sequentially. Alternatively, the multi-position bed is operated by one of the following, or by a combination thereof: (a) the user, (b) an operator who is not the user, (c) from any place where it is possible to control the operations of the multi-position bed via remote control or any other remote operating means as known in the art, or, (d) automatically, using methods known in the art.

In one embodiment, prior to executing the program, the multi-position bed activates a voice indicator which informs the user of the program to be executed. The program is activated only after the user confirms the voice-indication. The user may confirm execution of the program by any input means known in the art, such as pressing a confirmation button, or by voice-command.

In one embodiment, the multi-position bed features an interface from which a variety of operations are controlled. For example, the controller may be operated by the following means: manual, keyboard, voice-activation, computer-connected, for example via RS232 or USB, remote activation such as by telephone or wireless network, or by any other means known in the art. In one embodiment, all or some of the parameters that have been user-customized, such as user programs, angles, heights, and angular change velocity, are backed up. Parameters customized for the user may be saved in the multi-position bed or in any computer, or memory element, capable of communicating with the multi-position bed.

In one embodiment, the multi-position bed features a Built in Test (BIT). The BIT system may be used for swift identification of failures. This capability enables a technician to determine what action should be taken. The BIT also makes it easier to provide price quotes to a user prior to responding for repairs. Optionally, the BIT results may be transferred to the technician's equipment via a phone line or wireless network, or any other communication aid known in the art.

In one embodiment, when installing the multi-position bed at the user's site, the technician is able to set a combination of velocities, movement angles, and other parameters referred to herein as “operational customized parameters” of the multi-position bed such that it is possible to conform the use of the multi-position bed to the requirements, comfort and safety of the specific user. Optionally, the operational customized parameters are saved in a memory element for future use.

In an emergency, the multi-position bed may operate a predefined emergency response operation, such as, but not limited to, bringing the user to a predefined angular position. The angular position into which the user is brought in an emergency may be the most secure angular position for the specific user. Entering the emergency response operation may be initialized by any kind of appropriate device, such as, but not limited to, emergency button, emergency pull-rope, voice command, etc.

The embodiments of the present invention are not limited to the details of the order or sequence of steps of operation or implementation of the embodiments and corresponding method set in the description, drawings, or examples of the embodiments of the present invention.

While the invention has been described in conjunction with specific embodiments and examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations.

What is claimed is:

1. A multi-position support apparatus comprising: a foot support, a tilting element, and a moving frame; the foot support is coupled to the tilting element; and the moving frame is configured to move in relation to the tilting element and below the foot support.

2. The multi-position support apparatus of claim 1, further comprising a mattress supported by the moving frame, whereby the mattress moves below the foot support when the moving frame moves in relation to the tilting element.

3. The multi-position support apparatus of claim 1, further comprising a base element coupled to the tilting element.

4. The multi-position support apparatus of claim 1, wherein a user lies on the mattress and the moving frame is configured to move towards the foot of the multi-position support apparatus until the user's feet are close to or touch the foot support.

5. The multi-position support apparatus of claim 1, further comprising a lifting element coupled to the tilting element; the lifting element is configured to move up and down and thereby change the position of the tilting element and the foot support in relation to the floor.

6. The multi-position support apparatus of claim 5, wherein the foot support is approximately parallel to the ground when the tilting element is in maximum tilt and the lifting element is lowered.

7. The multi-position support apparatus of claim 5, wherein the tilting element is configured to tilt the moving frame into an approximately vertical position, such that the foot support is approximately parallel to the ground.

8. The multi-position support apparatus of claim 1, wherein the foot support is configured to change its position in relation to the tilting element.

9. The multi-position support apparatus of claim 1, further comprising angular support elements configured to change their relative angular positions.

10. The multi-position support apparatus of claim 9, wherein the multi-position support apparatus is further configured to change its angular position from a lying position to a sitting position.

11. The multi-position support apparatus of claim 9, wherein the multi-position support apparatus is further configured to change its angular position from a lying position to a standing position.

12. The multi-position support apparatus of claim 9, wherein the multi-position support apparatus is further configured to change its angular position from a sitting position to a standing position.

13. The multi-position support apparatus of claim 1, wherein the multi-position support apparatus comprises a back rest, a seat, and a leg rest; and further comprising a first angular support element configured to support the back rest, a second angular support element configured to support the seat, and a third angular support element configured to support the leg rest.

14. The multi-position support apparatus of claim 1, further comprising at least one engine configured to actuate the moving frame.

15. The multi-position support apparatus of claim 14, further comprising a control panel configured to allow a user to operate the engine to perform transition operations.

16. A method for controlling the relative position of a moving frame in relation to a foot support coupled to a tilting element, comprising: measuring whether a user's feet are close to or touch the foot support; and if not, shifting the moving frame towards the foot of the bed and under the foot support, until the user's feet touch the foot support.

17. The method of claim 16, wherein measuring whether the user's feet are close to or touch the foot support is performed using a sensor.

18. The method of claim 17, wherein the sensor is a pressure sensor.

19. The method of claim 17, wherein the sensor is a proximity sensor.

20. The method of claim 17, wherein the sensor is an electro-optics sensor.
